(19) United States
(12) Patent Application Publication
(10) Pub. No.: US 2018/0244328 A1
(43) Pub. Date: Aug. 30, 2018

(54) Ice Melting System

(71) Applicants: Paul Blushak, Welland (CA); Lou-Anne Blushak, Welland (CA)

(72) Inventors: Paul Blushak, Welland (CA); Lou-Anne Blushak, Welland (CA)

(21) Appl. No.: 15/445,268

(22) Filed: Feb. 28, 2017

(51) Int. Cl. B62D 63/08; B60S 1/66

(52) U.S. Cl. CPC B62D 63/08; H05B 2203/003; B60S 1/66

(57) ABSTRACT

An ice melting system for inhibiting frozen precipitation from collecting on a trailer includes a vehicle that has a trailer and the trailer has a top side. A heating unit provided and the heating unit is coupled to the top side of the trailer. The heating unit is electrically coupled to the vehicle. The heating unit is selectively turned on to melt frozen precipitation that has collected on the trailer. In this way the frozen precipitation is inhibited from breaking free and striking other vehicles.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to melting devices and more particularly pertains to a new melting device for inhibiting frozen precipitation from collecting on a trailer.

### BRIEF SUMMARY OF THE INVENTION

An embodiment of the disclosure meets the needs presented above by generally comprising a vehicle that has a trailer and the trailer has a top side. A heating unit provided and the heating unit is coupled to the top side of the trailer. The heating unit is electrically coupled to the vehicle. The heating unit is selectively turned on to melt frozen precipitation that has collected on the trailer. In this way the frozen precipitation is inhibited from breaking free and striking other vehicles.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a right side view of an ice melting system according to an embodiment of the disclosure.

FIG. 2 is a top phantom view of an embodiment of the disclosure.

FIG. 3 is a cross sectional view taken from circle 3 of FIG. 1 of an embodiment of the disclosure.

FIG. 4 is a cross sectional view taken from circle 4 of FIG. 1 of an embodiment of the disclosure.

FIG. 5 is a top perspective view of an embodiment of the disclosure.

### DETAILED DESCRIPTION OF THE INVENTION

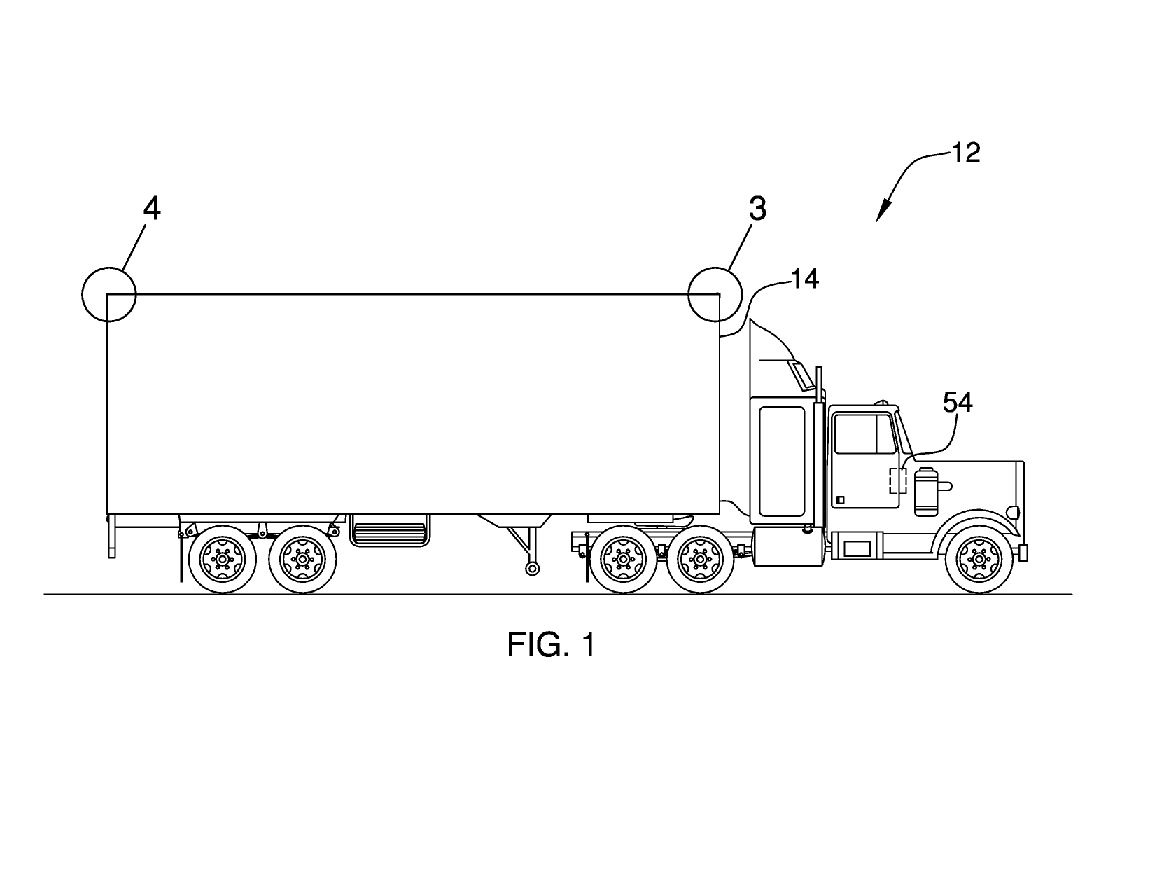

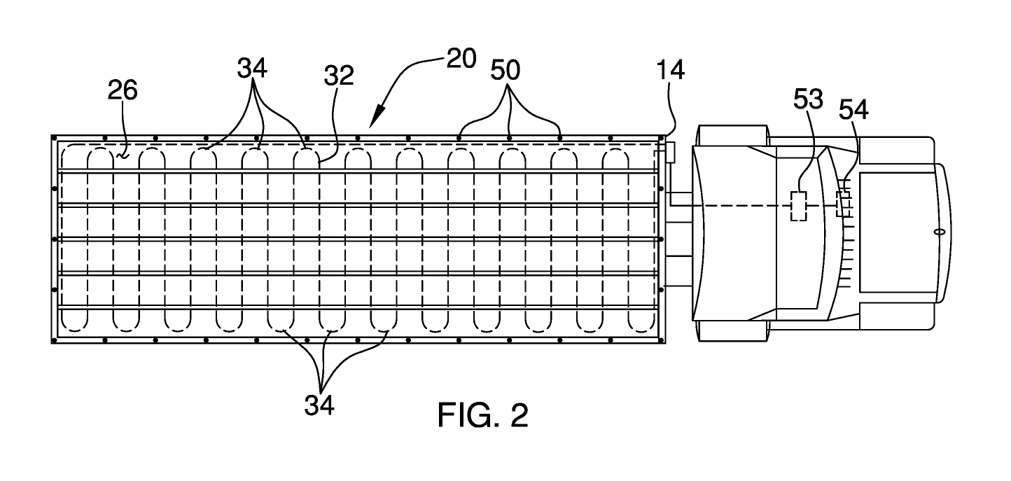

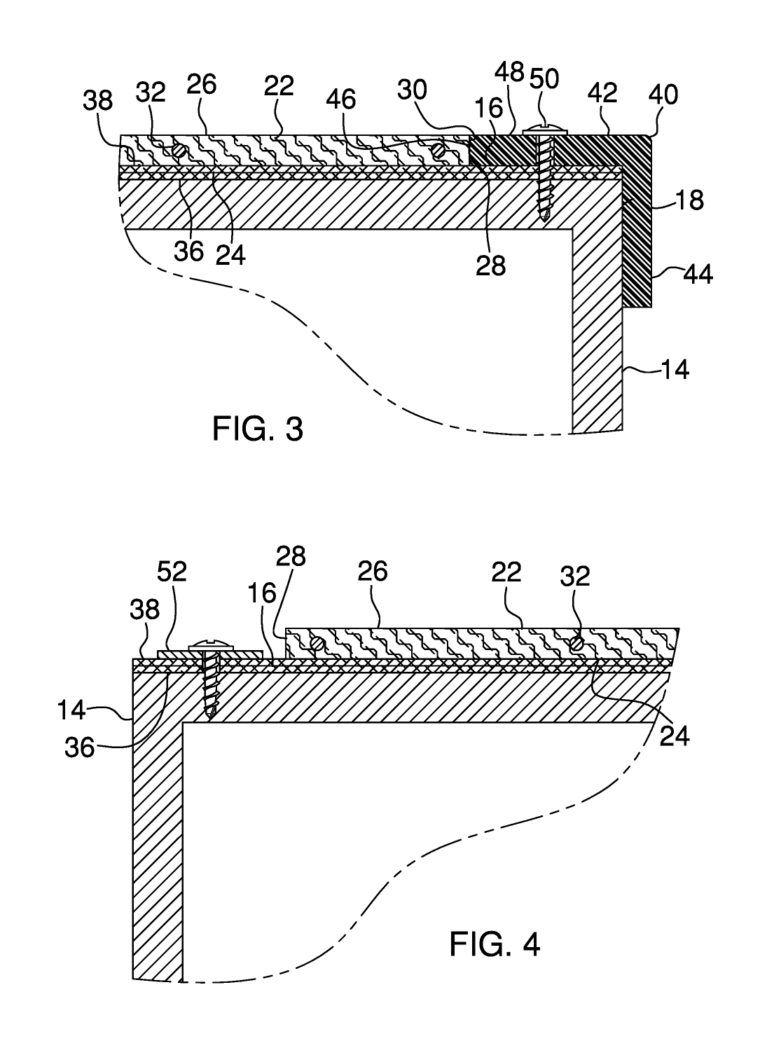

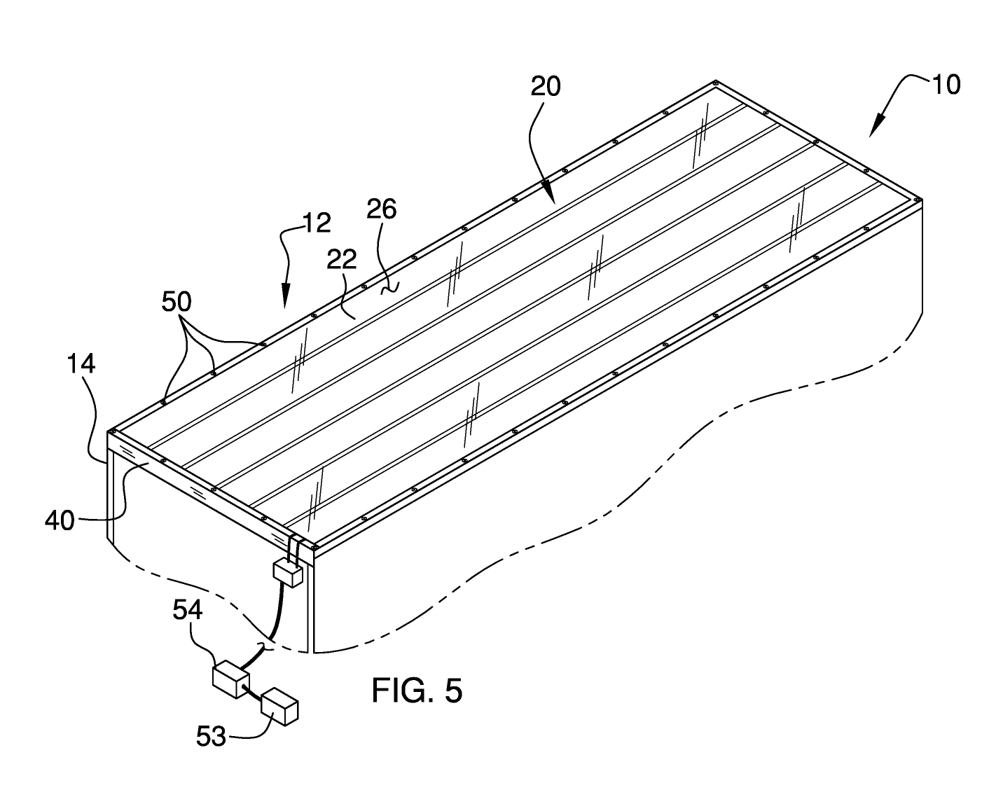

With reference now to the drawings, and in particular to FIGS. 1 through 5 thereof, a new melting device embodying the principles and concepts of an embodiment of the disclosure and generally designated by the reference numeral 10 will be described.

As best illustrated in FIGS. 1 through 5, the ice melting system 10 generally comprises a vehicle 12 that has a trailer 14 and the trailer 14 has a top side 16 and a forward edge 18. The vehicle 12 may be a semi tractor and the trailer 14 may be a semi trailer. A heating unit 20 is provided and the heating unit 20 is coupled to the top side 16 of the trailer 14. The heating unit 20 is electrically coupled to the vehicle 12 to melt frozen precipitation that has collected on the trailer 14. In this way the frozen precipitation is inhibited from breaking free and striking other vehicles.

The heating unit 20 comprises a sheet 22 that has a first surface 24, a second surface 26 and a peripheral edge 28 extending therebetween. The first surface 24 abuts the top side 16 of the trailer 14 and the sheet 22 substantially covers the top side 16. The frozen precipitation collects on the second surface 26 of the sheet 22. The frozen precipitation may be snow, ice, sleet or any other form of frozen precipitation. The peripheral edge 28 has a front side 30 and the sheet 22 is comprised of a fluid impermeable material.

A heating element 32 is provided and the heating element 32 is coupled to the sheet 22. The heating element 32 is in thermal communication with the sheet 22 to selectively melt the frozen precipitation on the second surface 26. The heating element 32 is positioned between the first surface 24 and the second surface 26 and the heating element 32 comprises a plurality of loops 34. The loops 34 are spaced apart from each other and are distributed along the sheet 22. The heating element 32 may be an electric heating element 32 or the like that has an operational temperature ranging between approximately 40.0 degrees Fahrenheit and 45.0 degrees Fahrenheit.

A first mating member 36 is provided and the first mating member 36 is coupled to the top side 16 of the trailer 14. The first mating member 36 is coextensive with a perimeter of the top side 16. A second mating member 38 is provided and the second mating member 38 is coupled to the first surface 24 of the sheet 22. The second mating member 38 is coextensive with the peripheral edge 28 of the sheet 22. Moreover, the second mating member 38 releasably engages the first mating member 36 such that the sheet 22 is retained on the trailer 14. Each of the first mating member 36 and the second mating member 38 may comprise complementary hook and loop fasteners 50 or the like.

A bracket 40 is provided that has a first section 42 forming an angle with respect to a second section 44. The first section 42 is coupled to the top side 16 of the trailer 14 and the second section 44 extends downwardly from the forward edge 18 of the trailer 14. Moreover, the bracket 40 is coextensive with the forward edge 18 of the trailer 14. The first section 42 has a distal edge 46 with respect to the second section 44 and a top surface 48. The front side 30 of the sheet 22 coextensively abuts the distal edge 46 and the top surface 48 is aligned with the second surface 26 of the sheet 22. In this way the bracket 40 inhibits wind from getting beneath the sheet 22 and potentially removing the sheet 22 from the trailer 14.

A plurality of fasteners 50 is provided and each of the fasteners 50 extends through the first mating member 36 and the second mating member 38. Each of the fasteners 50 engages the top side 16 of the trailer 14 to retain the sheet 22 on the trailer 14. The fasteners 50 are spaced apart from each other and are distributed around the perimeter of the top side 16. Each of the fasteners 50 may comprise a self taping screw or the like. Additionally, each of the fasteners 50 may include a washer 52 that is positioned between the fasteners 50 and the top side 16 of the trailer 14. The washer 52 may inhibit moisture from passing into the trailer 14 at a penetration point with respect to the fasteners 50. Moreover, the washer 52 may inhibit a head of the fastener 50 from passing through the sheet 52.

An inverter 53 is provided and the inverter 53 is positioned within the vehicle 12. Moreover, the inverter 53 is electrically coupled to the vehicle 12 to convert 12.0 VDC into 120.0 VAC. A control 54 is provided and the control 54 is positioned within the vehicle 12. The control 54 is electrically coupled to the inverter such that the control receives 120.0 VAC from the inverter and the control 54 is selectively manipulated. The control 54 is electrically coupled to the heating element 32 such that the control 54 turns the heating element 32 on and off. Additionally, the control 54 adjusts a temperature of the heating element 32 between a minimum temperature and a maximum temperature. The control 54 may include a switch, a button, a lever or any other conventional means of electrical control 54. The control 54 may additionally include a display that displays an operational temperature of the heating element 32.

In use, the control 54 is manipulated to turn the heating element 32 on when the vehicle 12 is being driven in winter conditions or other conditions that produce frozen precipitation. The heating element 32 heats the sheet 22 to melt the frozen precipitation on the sheet 22. Additionally, the heating element 32 inhibits the frozen precipitation from collecting on the sheet 22. In this way the heating element 32 inhibits the frozen precipitation from breaking free from the trailer 14 and striking other vehicles.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An ice melting system comprising:
a vehicle having a trailer, said trailer having a top side; and
a heating unit being coupled to said top side of said trailer, said heating unit being electrically coupled to said vehicle, said heating unit being selectively turned on wherein said heating unit is configured to melt frozen precipitation that has collected on said trailer thereby inhibiting the frozen precipitation from breaking free and striking other vehicles.

2. The system according to claim 1, wherein said heating unit comprises a sheet having a first surface, a second surface and a peripheral edge extending therebetween, said first surface abutting said top side of said trailer, said sheet substantially covering said top side, said second surface being configured to collect frozen precipitation.

3. The system according to claim 2, further comprising a heating element being coupled to said sheet such that said heating element is in thermal communication with said sheet wherein said heating element is configured to selectively melt the frozen precipitation, said heating element being positioned between said first surface and said second surface, said heating element comprising a plurality of loops, said loops being spaced apart from each other and being distributed along said sheet.

4. The system according to claim 1, further comprising a first mating member being coupled to said top side of said trailer, said first mating member being coextensive with a perimeter of said top side.

5. The system according to claim 4, further comprising:
a sheet having a first surface; and
a second mating member being coupled to said first surface of said sheet, said second mating member being coextensive with said peripheral edge of said sheet, said second mating member releasably engaging said first mating member such that said sheet is retained on said trailer.

6. The system according to claim 5, further comprising a plurality of fasteners, each of said fasteners extending through said first mating member and said second mating member, each of said fasteners engaging said top side of said trailer to retain said sheet on said trailer, said fasteners being spaced apart from each other and being distributed around said perimeter of said top side.

7. The system according to claim 3, further comprising a control being positioned within said vehicle wherein said control is configured to be manipulated, said control being electrically coupled to said vehicle, said control being electrically coupled to said heating element such that said control turns said heating element on and off.

8. An ice melting system comprising:
a vehicle having a trailer, said trailer having a top side; and
a heating unit being coupled to said top side of said trailer, said heating unit being electrically coupled to said vehicle, said heating unit being selectively turned on wherein said heating unit is configured to melt frozen precipitation that has collected on said trailer thereby inhibiting the frozen precipitation from breaking free and striking other vehicles, said heating unit comprising:
a sheet having a first surface, a second surface and a peripheral edge extending therebetween, said first surface abutting said top side of said trailer, said sheet substantially covering said top side, said second surface being configured to collect frozen precipitation,
a heating element being coupled to said sheet such that said heating element is in thermal communication with said sheet wherein said heating element is configured to selectively melt the frozen precipitation, said heating element being positioned between said first surface and said second surface, said heating element comprising a plurality of loops, said loops being spaced apart from each other and being distributed along said sheet,
a first mating member being coupled to said top side of said trailer, said first mating member being coextensive with a perimeter of said top side,
a second mating member being coupled to said first surface of said sheet, said second mating member being coextensive with said peripheral edge of said sheet, said second mating member releasably engaging said first mating member such that said sheet is retained on said trailer,
a plurality of fasteners, each of said fasteners extending through said first mating member and said second mating member, each of said fasteners engaging said top side of said trailer to retain said sheet on said trailer, said fasteners being spaced apart from each other and being distributed around said perimeter of said top side, and
a control being positioned within said vehicle wherein said control is configured to be manipulated, said control being electrically coupled to said vehicle, said control being electrically coupled to said heating element such that said control turns said heating element on and off.
